(19) United States
(12) Patent Application Publication
(10) Pub. No.: US 2025/0206935 A1
(43) Pub. Date: Jun. 26, 2025

(54) Rubber Composition and Hose Incorporating It

(71) Applicant: HUTCHINSON, PARIS (FR)

(72) Inventors: Gwenaëlle BIERCE-ARGY, Ferrières en Gatinais (FR); Sandrine HOUEE, AMILLY (FR)

(21) Appl. No.: 18/987,122

(22) Filed: Dec. 19, 2024

(30) Foreign Application Priority Data
Dec. 19, 2023 (FR) FR2314522

(51) Int. Cl. C08L 23/16; C08K 3/04; C08L 97/00; F16L 11/08

(52) U.S. Cl. CPC C08L 23/16; C08K 3/04; C08L 97/005; F16L 11/08; C08K 2201/005; C08L 2203/18; C08L 2205/025; C08L 2205/035; C08L 2205/08; C08L 2207/322; C08L 2312/00

(57) ABSTRACT

The invention relates to a rubber composition that can be used to form in the crosslinked state at least one layer of a hose (10), and a hose in which at least one layer (11, 13) is made up of this composition. The invention applies to any hose for transfer of a fluid under pressure, preferably a multilayer hose for automotive vehicle. The rubber composition according to the invention, based on at least one elastomer, comprises a reinforcing filler and a crosslinking system comprising sulfur and/or a peroxide, where the reinforcing filler comprises at least one recycled carbon black coming from shredding or thermal decomposition of used rubber-based articles, and a functionalized lignin in powdered form.

### CROSS-REFERENCE TO RELATED APPLICATIONS

This application claims priority from French Patent Application No. FR2314522 filed on Dec. 19, 2023. The French Patent Application is hereby expressly incorporated by reference herein in its entirety.

### FIELD OF THE INVENTION

The invention relates to a rubber composition based on at least one elastomer that can be used to form in the crosslinked state at least one layer of a hose, and a hose in which at least one layer is made up of this composition. The invention applies to a single layer or multilayer hose for conveying a fluid under pressure, preferably a multilayer hose conveying a fluid at a pressure equal to or over 2×10⁵ Pa, the fluid may be a liquid (e.g. water or cooling liquid), a supercritical gas or fluid (e.g. in an air conditioning circuit), a gas mixture (e.g. air in an air intake circuit), or a fuel. The invention applies generally to any hose for transfer of a fluid for a thermal engine, an electric motor or for a fuel cell (e.g. hydrogen) for an automobile, rail, aquatic, aeronautic or spatial vehicle, and also for any industrial facility or residence conveying a pressurized fluid.

### DESCRIPTION OF RELATED ART

As is well known, a rubber hose for an automobile vehicle cooling circuit usually comprises an inner layer designed to be in contact with the conveyed cooling liquid, at least one reinforcing structure on top of the inner layer (typically a reinforcement formed of knitted, twisted or braided yarn, for example PET, aramid or rayon), and an outer layer on top of the reinforcement and exposed to the air surrounding the hose. These inner and outer layers are typically made of a rubber composition reinforced with a filler comprising carbon black of fossil origin and reinforcing grade (i.e. conventional carbon black usually described as “virgin,” generally obtained by thermal decomposition or incomplete combustion of hydrocarbons), possibly coupled or replaced with a mineral reinforcing inorganic filler, such as silica or kaolin, for example.

Over recent years there has been a search to couple such a carbon black with another reinforcing filler of neither fossil nor mineral origin, i.e. a biosourced filler (coming from biomass), like for example lignin, in order to reduce the portion of fossil or mineral ingredients in the composition and in exchange increase the portion of biosourced ingredients. The following patent documents relating to rubber compositions for hoses comprising a partially biosourced reinforcing filler may in particular be mentioned.

WO 2023/025808 A1 has a rubber composition crosslinked by peroxide for example for a hose, which comprises:
in its examples 1-2:150 parts by mass of an EPDM rubber, 70 PCE of an “L1” lignin modified by hydrothermal treatment and 60 PCE of a virgin carbon black “N-550,” and
in its examples 3-4:100 parts by mass of an EPDM rubber, 50 PCE of an “L2” lignin modified by hydrothermal treatment and 50 PCE of the virgin carbon black “N-550.”

EP 4,059,996 A1 has a rubber composition crosslinked by sulfur for example for a hose, which comprises:
in its example Ab: 100 parts by mass of a nitrile-butadiene rubber (NBR), 40 PCE of an “HTC” lignin modified by hydrothermal treatment and 20 PCE of a virgin carbon black “N550,”
in its example Bb: 100 parts by mass of a polychloroprene rubber (CR), 40 PCE of the “HTC” lignin modified by hydrothermal treatment and 20 PCE of the virgin carbon black “N550,”
in its example Cb: 100 parts by mass of an EPDM rubber, 40 PCE of an “HTC” lignin and 20 PCE of the virgin carbon black “N550,”
in its example Db: 100 parts by mass of a natural rubber (NR), 40 PCE of the “HTC” lignin and 20 PCE of the virgin carbon black “N550.”
in its example Es: 100 parts by mass of a bromobutyl rubber (BIIR), 5 PCE of the “HTC” lignin modified by hydrothermal treatment and 55 PCE of ae virgin carbon black “N660,” and
in its example Eb: 100 parts by mass of a bromobutyl rubber (BIIR), 40 PCE of the “HTC” lignin modified by hydrothermal treatment and 20 PCE of the virgin carbon black “N660.”

A disadvantage of the rubber compositions tested in these examples from WO 2023/025808 A1 and EP 4,059,996 A1, which use a virgin carbon black and a modified lignin as reinforcing filler, resides in their reduced sustainable mass fraction which is at most 22% in said examples.

### BRIEF SUMMARY OF THE INVENTION

The goal of the present invention is to propose a rubber composition usable to form in the crosslinked state at least one layer of a hose, where the composition remediates in particular the aforementioned disadvantage from the prior art, while also being suitability for use in the crosslinkable state and having properties from the crosslinked state which are both satisfactory for said layer of the hose.

This goal is achieved in that the Applicant just discovered that if, in a composition of rubber crosslinkable with sulfur or peroxide, a mixed-reinforcing filler is used comprising:
a recycled carbon black coming from shredding and thermal decomposition of used rubber-based articles; and
a functionalized lignin in powdered form;
then at least one layer of a hose may be obtained having, in comparison to a “control” rubber composition distinguished solely from the composition from the invention by the use of a virgin (i.e. non-recycled) carbon black coupled to the same functionalized lignin:
   in the crosslinkable state: a suitability for use and a scorch resistance which are globally retained, even improved; and
   in the crosslinked state: physical and mechanical properties which are substantially retained, even improved, and which are not globally more penalized than the “control” composition following thermal-oxidizing aging;
so as to confer to a hose characteristics for use and properties in operation at least equivalent compared to a hose incorporating said “control” composition.

In other words, a rubber composition according to the invention, which is based on at least one elastomer, can be used to form in the crosslinked state at least one layer of a hose and comprises a reinforcing filler and a crosslinking system comprising sulfur and/or a peroxide, and as such that the reinforcing filler comprises:
at least one recycled carbon black coming from shredding or thermal decomposition of used rubber-based articles; and
a functionalized lignin in powdered form.

The expression “a rubber composition usable to form in the crosslinked state at least one layer of a hose” is understood to mean a rubber composition for hose, based on at least one elastomer.

The expression “based on” is understood to mean in the present description that the composition or ingredient considered comprises by weight mostly the constituent in question, i.e. at a fraction by mass over 50%, preferably over 75% and which may range up to 100%.

“At least one recycled carbon black coming from shredding and thermal decomposition of used rubber-based articles” is understood to mean that said or each recycled carbon black (i.e. non-virgin carbon black, also called “recovered carbon black”) is essentially obtained by shredding, and then by high temperature decomposition of the shreds (such as pyrolysis, (vapor) thermolysis or de-vulcanization) of a used article made of at least one rubber or else mostly made up of at least one rubber (such as a tire, hose, joint, belt or any other rubber industrial product). “Shredding” and “shred” are understood generically in the present description to mean respectively breaking possibly supplemented by shredding of the used rubber-based article, and the product of the successive operations of breaking and possibly shredding applied to the used articles.

“Functionalized lignin” in the present description is understood to mean a carbon lignin which is modified by thermal hydrolysis or by another method for modification/purification, with which to get a purified lignin extract. As is well known, lignin is a major component of lignocellulosic biomass, made up of a phenolic-polymer type branched macromolecule comprising in particular carbonyl (C═O), aliphatic hydroxyl and phenolic hydroxyl functional groups. The functionalized lignin usable in the invention may have in particular all or part of these functional groups.

According to implementation examples from the invention, the functionalized lignin in powder form comprises:
particles without surface CO or COO group; and/or
is a kraft lignin, for example, coming from wood of gymnosperm trees, such as conifers.

Note that the combination of said at least one recycled carbon black and the functionalized lignin serves to confer to the crosslinked composition according to the invention (both with sulfur and with peroxide) physical properties (e.g. density, hardness, volume resistivity) and mechanical properties (e.g. M100 secant modulus at 100% deformation, elongation and stress at break, compression set) which are each sufficient for the hose according to the invention, for which at least one layer is made up of this composition, and have properties for use and functional properties (e.g. pressure resistance, dynamic performance and aging resistance) equivalent to those of the hose incorporating said “control” composition (which is distinguished from the invention composition only in that the carbon black coupled to the same functionalized lignin is virgin).

Advantageously, said at least one recycled carbon black may have reinforcement properties of the composition analogous to those of reinforcing-grade virgin carbon black selected from the ASTM N300, N400, N500, N600 and N700 series, for example analogous to those of carbon black from N500 or N600 series (e.g. analogous to those of an N550 or N660 black, nonlimiting).

According to another aspect of the invention, the composition comprises, in addition to said at least one elastomer, the crosslinking system and the functionalized lignin in powdered form:
a recycled pulverulent mixture which comprises the product of a thermal decomposition reaction by thermolysis, pyrolysis or de-vulcanization, applied to shreds of said used rubber-based articles;
the recycled pulverulent mixture comprising said at least one recycled carbon black and being for example micronized, in particular in the case where said reaction is thermolysis or pyrolysis.

Advantageously, the recycled pulverulent mixture may comprise said at least one recycled carbon black according to a fraction by mass included between 80% and 99%, and inorganic substances at a fraction by mass included between 1% and 20%, comprising in particular silicon oxides and/or zinc compounds, where the recycled pulverulent mixture in micronized form comes for example from pyrolysis of used tires.

In the present description “reinforcing filler” is understood to mean a filler comprising individual reinforcing grade fillers for said at least one elastomer which are homogeneously dispersed in the composition, with it specified that the reinforcing filler may further comprise:
a reinforcing organic filler other than said at least one recycled carbon black, e.g.
a virgin carbon black of identical or different grade compared to that of the recycled carbon black, and/or another carbon filler (e.g. graphite or carbon nanotubes); and/or
a reinforcing inorganic filler (e.g. a clear filler, such as silica) which may be of mineral or biosourced origin.

According to a preferential embodiment of the invention which may include any one of the aforementioned characteristics, the reinforcing filler may further comprise at least one virgin (i.e. not recycled) carbon black having for example a BET specific surface area measured according to the ASTM D 6556 standard which is included between 10 and 50 m²/g and for example from 15 to 30 m²/g, such as a carbon black from N500 or N600 series (e.g. N550 or M660, without limitation).

According to another general characteristic of the invention which may include any one of the aforementioned characteristics, the composition may comprise 10-120 PCE of said at least one recycled carbon black and 2-90 PCE of the functionalized lignin (PCE: parts by weight for 100 parts of elastomer(s)).

Note that the incorporation of the functionalized lignin in the reinforcing filler is not contrary to the use of a large quantity of carbon black in the composition, serving to give it satisfactory mechanical properties.

According to another general characteristic of the invention which may include any one of the aforementioned characteristics, said at least one elastomer may be selected from the ethylene-propylene-diene terpolymers (EPDM), the isobutylene-isoprene copolymers (IIR), the halogen isobutylene-isoprene copolymers (XIIR), the silicone rubbers, the fluoro silicone rubbers, the acrylic rubbers such as polyacrylate (ACM) and ethylene polyacrylate (AEM), and the bromine copolymers of isobutylene-para-methylstyrene. According to an embodiment, said at least one elastomer may be selected from the ethylene-propylene-diene terpolymers (EPDM) and acrylic rubbers such as polyacrylate (ACM) and ethylene polyacrylate (AEM).

It will however be noted that other rubbers than those aforementioned can be used in the composition according to the invention, as a function of the property sought for the or each layer of the hose.

According to a specific embodiment of the invention:
said at least one elastomer is made up of at least one EPDM;
the crosslinking system comprises a peroxide or sulfur; and
the composition comprises 15-100 PCE of said at least one recycled carbon black and 5-80 PCE of the functionalized lignin.

Preferably, said at least one EPDM, not oil-extended, has:
levels by mass of units coming from ethylene of 52-70%, from a non-conjugated diene (such as ethylidene norbornene) of 4 to 7%, and further preferably
a Mooney viscosity ML (1+4) at 125° C. included between 70 and 90.
A mixture of two EPDM not oil-extended may for example be used, of which one has a level by mass of units coming from ethylene of 53-57% and a Mooney viscosity ML (1+4) at 125° C. included between 75 and 85, and of which the other has a level by mass of units coming from ethylene of 66-70% and a Mooney viscosity ML (1+4) at 125° C. included between 80 and 90.

to another general aspect of the invention which may relate to any one of the aforementioned characteristics, the composition of the invention, for example based on at least one EPDM, comprises:
10-80 PCE of said at least one virgin carbon black, having for example a BET specific surface area measured according to the ASTM D 6556 standard which is included between 10 and 50 m²/g;
10-80 PCE, preferably 15-80 PCE, of said at least one recycled carbon black; and
15-80 PCE of said functionalized lignin;
where the sum of the quantities of said at least one virgin carbon black and said at least one recycled carbon black in the composition is 60-110 PCE.

Still more preferably, according to another general aspect of the invention which may relate to any one of the aforementioned characteristics, the sum of the quantities of said at least one virgin carbon black and said at least one recycled carbon black in the composition according to the invention, for example based on at least one EPDM, is 70-100 PCE, and
the sum of the quantities of said at least one virgin carbon black, recycled carbon black, and the functionalized lignin in the composition is 100-130 PCE.

Also preferred, the reinforcing filler comprises:
the functionalized lignin according to a fraction by mass of 15-30%; and
said at least one virgin carbon black and said at least one recycled carbon black according to a fraction by total mass of carbon black of 70-85%.

According to another general aspect of the invention which may relate to any one of the aforementioned characteristics, the composition according to the invention, for example based on at least one EPDM or at least acrylic rubber such as (ACM) or (AEM), may advantageously have in the crosslinked state a resistivity per unit volume over 10⁶ Ohm·cm, preferably over 10⁸ Ohm·cm and still more preferably over 10¹² Ohm·cm, measured according to IEC 62631 3 standard.

Note that these compositions according to the invention, for example based on at least one EPDM or at least acrylic rubber such as (ACM) or (AEM), thus have a high resistivity because of said functionalized lignin, despite the use of a large quantity of carbon black which is known to penalize this resistivity (by increasing the electrical conductivity). This high resistivity serves in particular to minimize the electrochemical breakdown of the inner layer of the hose in contact with the fluid that it conveys, when this fluid is a cooling liquid for example of glycolated-water type, without penalizing the resistance of the hose to the outside environment thereof.

Note that the use of a recycled carbon black allows for a better resistivity compared to a composition comprising a virgin carbon black.

Further, note that the aforementioned quantities used for said at least one recycled carbon black, the functionalized lignin and optionally said at least one virgin carbon black combined with the use of a suited plasticizer system serve to limit the Mooney ML (1+4) viscosity at 100° C. for the crosslinkable composition (whatever the elastomer matrix used) all while opposing the premature crosslinking (scorch) thereof, thus making the composition from the invention suited for being used by mixing then extrusion.

As a plasticizer system for the composition according to the invention, at least one plasticizer oil and/or at least one plasticizer resin may be used, with it specified that the plasticizer system according to the invention preferably comprises at least one oil selected from mineral oils, oils coming from the biomass (including modified or unmodified vegetable oils), and mixtures thereof.

Still more preferred, as a plasticizer system, at least one oil is used selected from paraffinic, naphthenic and aromatic mineral oils, for example an at least partial naphthenic mineral oil (which may comprise both paraffinic, naphthenic and aromatic functions).

Concerning said crosslinking system, it serves to chemically crosslink the rubber composition by subsequent vulcanization of the hose comprising the or each layer made up of the composition, at a temperature for example included between 16° and 200° C. This crosslinking system, if it uses peroxide, may comprise an organic peroxide and a crosslinking co-agent, for example, selected from triallyl cyanurate (TAC) and triallyl isocyanurate (TAIC).

According to another general aspect of the invention which may relate to any one of the aforementioned characteristics, the composition may have a fraction by mass of sustainable ingredients (i.e. biosourced and recycled), in which sustainable ingredients include said at least one recycled carbon black and said functionalized lignin, that is over 10%, preferably over 20 or 25%, more preferably over 30%, for example equal to or greater than 40%.

Note that said sustainable ingredients, present in the composition according to more than 25%, 30% even 40%, may be made up of said at least one recycled carbon black and said functionalized lignin, or else as a variant further include one or more sustainable ingredients.

According to another general aspect of the invention, the crosslinkable rubber compositions from the invention are prepared by using a method essentially comprising the following successive steps:
a) adding the ingredients of the composition, except for the crosslinking system, to an internal mixer;
b) thermomechanical working in a step in this internal mixer, until reaching a maximum “dropping” temperature for example of 120-130° C.;
c) recovering then cooling the resulting mixture; then
d) adding the crosslinking system with sulfur or peroxide to an external mixer (e.g. cylinders) at a temperature of 95-105° C., with mechanical work in this outer mixer of the resulting crosslinkable composition.

As a variant, the crosslinking system may be added during step b) of thermomechanical work with a control of the maximum temperature at 120° C., for example, or else during a second introduction in the internal mixer following cooling of the precursor mix resulting from the first step.

As the results shown in the following examples attest, the physical properties (e.g. density, hardness, volume resistivity) and mechanical properties (e.g. M100 at 100% deformation, elongation and stress at break, compression set) of the crosslinked compositions according to the invention are globally sufficient so that hoses incorporating them convey with a good dynamic strength a fluid at a pressure of at least 2×10⁵ Pa, even after thermal-oxidizing aging at 150° C. for 168 hours.

A hose according to an embodiment of the invention for transferring a liquid, gaseous or supercritical fluid for thermal or electric motor, or for fuel cell for an automobile, rail, aquatic, aerial or spatial vehicle, the hose comprising a radially inner tube of rubber, at least one reinforcing layer and one cover layer of rubber is suited for conveying the fluid at a pressure equal to or over 2×10⁵ Pa.

A hose according to this embodiment of the invention is such that one at least of the inner tube and the covering layer is made up of a rubber composition in the crosslinked state such as defined above.

Note that the hose according to this embodiment may further comprise a barrier layer of a plastic based on at least one thermoplastic polymer. This barrier layer may form the most radially inward layer of the hose, or else an “insulating layer” between the inner tube and a reinforcing layer or between the inner tube and a rubber intermediate layer.

According to another general aspect of the invention which may relate to any one of the aforementioned characteristics, the rubber composition for hose, based on at least one elastomer, comprises a reinforcing filler and a crosslinking system comprising sulfur and/or a peroxide,
wherein the reinforcing filler comprises
(i) a recycled pulverulent mixture which comprises the product of a thermal decomposition reaction by thermolysis, pyrolysis or de-vulcanization, applied to shreds of used rubber-based articles,
said recycled pulverulent mixture comprising:
at least one recycled carbon black according to a fraction by mass included between 80% and 99%, and
inorganic substances at a fraction by mass included between 1% and 20%, comprising in particular silicon oxides and/or zinc compounds;
(ii) a functionalized lignin in powdered form, and
(iii) optionally, at least one virgin carbon black, having for example a BET specific surface area measured according to the ASTM D 6556 standard which is included between 10 and 50 m²/g.

According to another general aspect of the invention which may relate to any one of the aforementioned characteristics, the recycled pulverulent mixture is micronized, and comprises the product of a thermal decomposition reaction by thermolysis, pyrolysis applied to shreds of used rubber-based articles.

According to another general aspect of the invention which may relate to any one of the aforementioned characteristics, the recycled pulverulent mixture is from pyrolysis of used tires.

### BRIEF DESCRIPTION OF THE DRAWINGS

Other features, advantages and details of the invention will emerge upon reading the following description of several examples of implementation of the invention, given for illustration in connection with the attached drawings, among which:

FIG. 1 is a lateral and perspectives schematic view with partial callouts of a multilayer hose according to an example of the invention.

FIG. 2 is a lateral and perspectives schematic view with partial callouts of a multilayer hose according to another example of the invention.

FIG. 3 is a lateral and perspectives schematic view with partial callouts of a multilayer hose according to another example of the invention.

FIG. 4 is a lateral and perspectives schematic view with partial callouts of a multilayer hose according to another example of the invention.

### DETAILED DESCRIPTION OF THE INVENTION

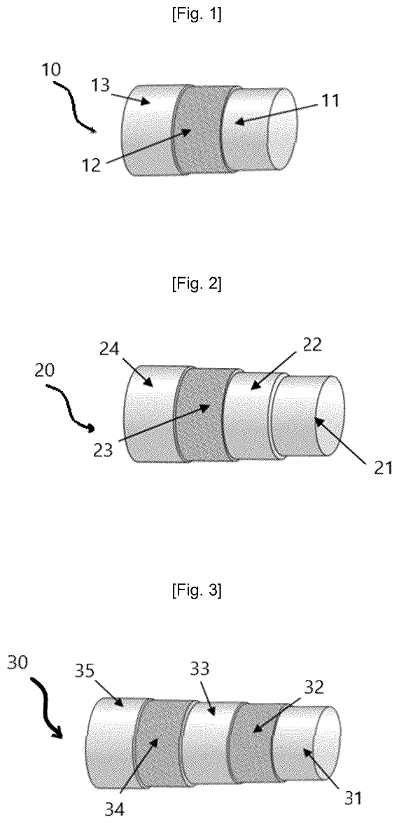

The multilayer hose 10 from FIG. 1 is capable of conveying any fluid such as those already mentioned, at a pressure preferably equal to or over 2×10⁵ Pa, and it comprises a radially inner tube 11, a reinforcement layer 12 and a radially outer cover layer 13, with it specified that at least one of the tube 11 and the covering layer 13 is made up of a rubber composition according to the invention such as defined above, e.g. based on at least one:
EPDM, in particular in the case of a hose conveying water or cooling liquid for a thermal engine, electric motor or fuel cell for an automotive vehicle; or
ACM or AEM (e.g. Vamac® type), in particular in the case of a hose conveying air (e.g. air intake for an automobile motor vehicle).

As explained above, the tube 11 and the cover layer 13 may, as a variant, each be based on at least one IIR or XIIR (halobutyl rubber, e.g. chlorinated or brominated), at least one silicon rubber optionally with fluorine (e.g. MQ, PMQ, PVMQ, VMQ or FMQ, FVMQ) or at least one brominated copolymer of isobutylene-p-methylstyrene (e.g. Exxpro® tradename).

The reinforcement layer 12 may comprise, without limitation, a knit, twist or braid based on multifilament yarn made of one or more textile material(s), for example a polyamide (e.g. aramid), polyester (e.g. PET) or rayon (where the term “yarn” designates as usual both a thread based on a multitude of elementary small-diameter filaments which are twisted together and a plied obtained by torsion of several threads).

The multilayer hose 20 from FIG. 2 is distinguished from that from FIG. 1 in that inner tube 21 is covered up by an intermediate layer 22 itself covered up by a reinforcement layer 23 covered by the cover layer 24, with it specified that one at least of the tube 21 and cover layer 24 is made up of a composition according to the invention.

The multilayer hose 30 from FIG. 3 is distinguished from that from FIG. 2 in that inner tube 31 is covered up by an inner reinforcing layer 32 itself covered up by an intermediate layer 33, covered by an outer reinforcing layer 34, then a cover layer 35, with it specified that one at least of the tube 31, intermediate layer 33 and cover layer 35 is made up of a composition according to the invention.

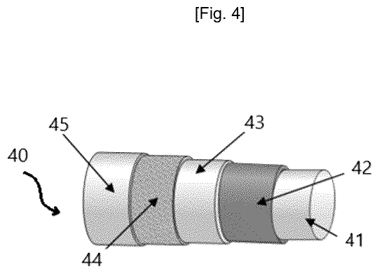

The multilayer hose 40 from FIG. 4 is distinguished from that from FIG. 2 in that inner tube 41 is covered up by a barrier layer 42 of plastic forming a ply, then an intermediate layer 43 covered with the reinforcing layer 44, itself covered up by a cover layer 45, with it specified that one at least of the tube 41, intermediate layer 43 and cover layer 45 is made up of a composition according to the invention.

Note that a multilayer hose according to the invention could comprise an arrangement of layers different from those shown in FIGS. 1-4, both in the number of the layers thereof and in the respective functions thereof.

### Preparation of a Control Composition C1, of Compositions not Conforming to the Invention C2-C6, and Compositions According to the Invention I1-I8:

The control rubber composition C1, the rubber compositions not conforming to the invention C2-C6 and the rubber compositions according to the invention I1-I8, were prepared essentially by making use of the following method.

The ingredients for each composition, except for the crosslinking system, were added to a Banbury® type internal mixer. Then, thermomechanical work was done in one step (mixing length: 30 s to 2 min.), until reaching a maximum “dropping” temperature of about 125° C.

The resulting mixture was recovered, cooled, then the crosslinking system was added in an outer mixer with cylinders at 100° C., while mixing everything for about 2 min., in a mechanical work step.

The resulting crosslinkable rubber compositions C1-C6 and I1-I8 were then shaped as cylindrical test pieces for undergoing measurement of properties in the non-crosslinked state (Mooney viscosity and scorch time), and as dumbbell-shaped test pieces for performing measurements of mechanical properties in the crosslinked state after vulcanization of the test piece at 180° C. (hardness, M100 secant modulus at 100% deformation and properties at break).

For each cylindrical type crosslinkable test piece, the Mooney ML (1+4) viscosity at 100° C. was measured according to the ISO 289-1 standard and the scorch time t5 without premature crosslinking was measured at 135° C. according to the ISO 289-2 standard.

Further, for each dumbbell type crosslinked test piece, the following were measured:
a) the density, according to ISO 2781 standard;
b) the Shore A hardness after 3 s according to the ISO 48-4 standard;
c) the M100 secant modulus in uniaxial traction according to the ISO 37:2017 standard;
d) the stress at break and the elongation at break in uniaxial traction according to the ISO 37:2017 standard;
e) the compression set:
   at 25%: 72 hours/130° C. after 30 minutes, according to the ISO 815-1 standard (method B); and
   at 25%: after 72 hours/140° C. (“FCA” specification: Fiat Chrysler Automobiles) according to the ISO 1817 standard; and
f) volume resistivity measured at 1000 V.

Each test piece made up of the rubber compositions C1-C₆ and I1-I8 was subject to a thermal-oxidizing aging under hot air for 168 hours at 150° C., then the hardness, and stress and elongation at break were measured again as specified in b) and d) above.

The following Table 1 gives the formulations of the compositions C1-C3 and I1-I5 prepared as indicated above.

TABLE 1

| | C1 | C2 | C3 | I1 | I2 | I3 | I4 | I5 |
|---|---|---|---|---|---|---|---|---|
| EPDM 1* | 60 | 60 | 60 | 60 | 60 | 60 | 60 | 60 |
| EPDM 2* | 40 | 40 | 40 | 40 | 40 | 40 | 40 | 40 |
| Virgin carbon black * | 57.5 | 115 | | 38.3 | 19.2 | | 76.6 | 19.2 |
| Lignin * | 57.5 | | 115 | 38.3 | 76.6 | 57.5 | 19.2 | 19.2 |
| Recycled carbon black * | | | | 38.3 | 19.2 | 57.5 | 19.2 | 76.6 |
| Plasticizer * | 40 | 40 | 40 | 40 | 40 | 40 | 40 | 40 |
| MgO | 5.7 | 5.7 | 5.7 | 5.7 | 5.7 | 5.7 | 5.7 | 5.7 |
| PEG 4000 | 1.9 | 1.9 | 1.9 | 1.9 | 1.9 | 1.9 | 1.9 | 1.9 |
| Agent used * | 3 | 3 | 3 | 3 | 3 | 3 | 3 | 3 |
| Quinoline antioxidant | 1 | 1 | 1 | 1 | 1 | 1 | 1 | 1 |
| Imidazole antioxidant | 1 | 1 | 1 | 1 | 1 | 1 | 1 | 1 |
| TAC co-agent | 1 | 1 | 1 | 1 | 1 | 1 | 1 | 1 |
| Organic bis-peroxide | 10.5 | 10.5 | 10.5 | 10.5 | 10.5 | 10.5 | 10.5 | 10.5 |
| TOTAL | 279.1 | 279.1 | 279.1 | 279.0 | 279.1 | 279.1 | 279.1 | 279.1 |
| Fraction by mass of | 20% | 0% | 41% | 27% | 34% | 41% | 14% | 34% |
| sustainable ingredients | | | | | | | | |

The following Table 2 gives the formulations of the compositions C4-C6 and I6-I8 prepared as indicated above

TABLE 2

| | C4 | C5 | C6 | I6 | I7 | I8 |
|---|---|---|---|---|---|---|
| AEM 1 * | 68.3 | 68.3 | 68.3 | 68.3 | 68.3 | 68.3 |
| AEM 2 * | 31.3 | 31.3 | 31.3 | 31.3 | 31.3 | 31.3 |
| Plasticizer (ester) | 5.6 | 5.6 | 5.6 | 5.6 | 5.6 | 5.6 |
| Virgin carbon black * | | 60 | | 20 | 40 | 10 |
| Recycled carbon black * | | | 60 | 20 | 10 | 40 |
| Lignin * | 60 | | | 20 | 10 | 10 |
| Crosslinking agent | 1.3 | 1.3 | 1.3 | 1.3 | 1.3 | 1.3 |
| (carbamate) | | | | | | |
| Antioxidant (amine) | 2 | 2 | 2 | 2 | 2 | 2 |
| Implementation agent | 1.5 | 1.5 | 1.5 | 1.5 | 1.5 | 1.5 |
| (acid) | | | | | | |
| Retardant (acid) | 1.5 | 1.5 | 1.5 | 1.5 | 1.5 | 1.5 |
| Implementation agent | 1 | 1 | 1 | 1 | 1 | 1 |
| (acid) | | | | | | |
| Implementation agent | 1.5 | 1.5 | 1.5 | 1.5 | 1.5 | 1.5 |
| (polymeric lubricant) | | | | | | |
| Accelerator | 3.7 | 3.7 | 3.7 | 3.7 | 3.7 | 3.7 |
| (guanidine type) | | | | | | |
| TOTAL | 177.7 | 177.7 | 177.7 | 177.7 | 177.7 | 177.7 |
| Fraction by mass of | 33.8% | 0% | 33.8% | 22.5% | 11.3% | 28.1% |
| sustainable ingredients | | | | | | |

The ingredients used for these compositions identified in Tables 1 and 2 by the * sign have the following characteristics:
EPDM 1: concentration by mass of units coming from ethylene: 55%; of units coming from norbornene ethylidene: 5.5%; and Mooney ML (1+4) viscosity at 125° C.: 80.
EPDM 2: concentration by mass of units coming from ethylene: 68%; of units coming from norbornene ethylidene: 4.9%; and Mooney ML (1+4) viscosity at 125° C.: 85.
AEM 1: terpolymer composed of ethylene units, methyl acrylate units and a crosslinking site and Mooney ML (1+4) viscosity at 100° C. of 16,5
AEM 2:: terpolymer composed of ethylene units, methyl acrylate units and a crosslinking site and Mooney ML (1+4) viscosity at 100° C. of 18,5
Virgin carbon black (table 1, EPDM matrice): grade 6, BET specific surface area according to ASTM D 6556 20 m²/g, and iodine absorption index according to ASTM D 1510 20 mg/g.
Virgin carbon black (table 2, AEM matrice): grade 5, BET specific surface area according to ASTM D 6556 40 m²/g, and iodine absorption index according to ASTM D 1510 43 mg/g.
lignin: kraft lignin coming from gymnosperm-tree wood, such as conifers, sold by UPM under product number TSD020-1000.
Recycled carbon black from pyrolysis of used tires and sold by Contact under the name Conblack®.
Plasticizer: paraffinic mineral oil.
Agent used: mixture of fatty acid derivatives.

Table 3 below shows the essential rheological properties of the resulting compositions C1-C3 and I1-I5, including for each of them:
the Mooney ML (1+4) viscosity at 100° C. measured according to the ISO 289-1 standard;
the initial scorch time t5 without premature crosslinking at 135° C. according to the ISO 289-2 standard; and
the rheological properties: time ts1 and t10, t50, t70, t90 (beginning to end of crosslinking) measured by an oscillating matrix rheometer (20 minutes at 180° C.) according to the ISO 6502 standard.

TABLE 3

| | | C1 | C2 | C3 | I1 | I2 | I3 | I4 | I5 |
|---|---|---|---|---|---|---|---|---|---|
| ML(1 + 4) at 100° C. | | 99.3 | 97.2 | 109.8 | 94.3 | 99.6 | 104.1 | 97.5 | 97.3 |
| Scorch time t5 in | | 12.74 | 13.28 | 10.65 | 13.03 | 12.74 | 10.35 | 12.17 | 10.80 |
| minutes (30 | | | | | | | | | |
| minutes at 135° C.) | | | | | | | | | |
| Rheology: | ts1 | 0.61 | 0.57 | 0.62 | 0.54 | 0.59 | 0.58 | 0.52 | 0.50 |
| time in | t10 | 0.64 | 0.66 | 0.67 | 0.60 | 0.64 | 0.63 | 0.58 | 0.57 |
| minutes | t50 | 1.74 | 1.96 | 1.76 | 1.68 | 1.73 | 1.66 | 1.69 | 1.63 |
| (20 minutes | t70 | 2.83 | 3.15 | 2.82 | 2.77 | 2.81 | 2.74 | 2.80 | 2.74 |
| at 180° C.) | t90 | 5.4 | 5.87 | 5.3 | 5.37 | 5.34 | 5.35 | 5.48 | 5.37 |

Table 4 below shows the physical and mechanical properties of the resulting crosslinked compositions C1-C3 and I1-I5 measured as indicated above on dumbbell type test pieces.

TABLE 4

| | C1 | C2 | C3 | I1 | I2 | I3 | I4 | I5 |
|---|---|---|---|---|---|---|---|---|
| Density (g/cm³) | 1.109 | 1.162 | 1.063 | 1.133 | 1.098 | 1.116 | 1.150 | 1.154 |

Before thermal-oxidizing aging

| | | | | | | | | |
|---|---|---|---|---|---|---|---|---|
| Shore A hardness | 64 | 65 | 65 | 66 | 65 | 66 | 66 | 66 |
| Stress at break (MPa) | 9.21 | 13.4 | 6.72 | 8.46 | 7.04 | 7.54 | 9.82 | 9.33 |
| Elongation at break (%) | 323 | 310 | 248 | 302 | 260 | 278 | 260 | 278 |
| M100 modulus (MPa) | 3.88 | 3.78 | 3.97 | 3.46 | 3.51 | 3.45 | 3.94 | 3.40 |

After thermal-oxidizing aging for 168 hours at 150° C.

| | | | | | | | | |
|---|---|---|---|---|---|---|---|---|
| Shore A hardness | 66 | 71 | 67 | 71 | 68 | 71 | 71 | 74 |
| Δ Shore A hardness | +2 | +6 | +2 | +5 | +3 | +5 | +5 | +8 |
| Stress at break (MPa) | 8.78 | 12 | 7.09 | 7.31 | 6.68 | 6.41 | 8.57 | 7.62 |
| Δ (%) stress at break | −5% | −10% | 6% | −14% | −5% | −15% | −13% | −18% |
| Elongation at break (%) | 195 | 265 | 155 | 138 | 143 | 118 | 161 | 127 |
| Δ (%) elongation at break | −40% | −15% | −38% | −54% | −45% | −58% | −38% | −54% |

Compression Set

| | | | | | | | | |
|---|---|---|---|---|---|---|---|---|
| 25%: 72 hours/130° C. | 27.4 | 28.4 | 28.7 | 48.3 | 48.5 | 71.2 | 30.1 | 31.5 |
| after 30 minutes, per | | | | | | | | |
| ISO 815-1 (method B) | | | | | | | | |
| 25%: 72 hr/140° C. | 38.9 | 43.0 | 39.1 | 54.0 | 52.7 | 88.2 | 40.1 | 44.2 |
| “FCA” per ISO 1817 | | | | | | | | |

Volume resistivity at 1000 V

| | | | | | | | | |
|---|---|---|---|---|---|---|---|---|
| in Ω · cm | 6.4 × | 1.5 × | 4.9 × | 7.2 × | 5.8 × | 6.1 × | 3.2 × | 6.2 × |
| | 10¹³ | 10⁶ | 10¹³ | 10¹³ | 10¹³ | 10¹³ | 10¹² | 10¹³ |

The set of properties obtained in Tables 3-4 for the compositions I1-I5 according to the invention show, in comparison with the control composition C1 (comprising a mixture of 50% of the same virgin carbon black and 50% of the same lignin as reinforcing filler):
in the non-crosslinked state, a globally retained suitability for use for the compositions I1-I5 and even improved for I1, I2, I4 and I5 (see, in particular, their reduced viscosity ML (1+4) compared to that of the composition C1); and
in the crosslinked state:
   globally maintained mechanical properties (even after thermal-oxidizing aging) for the compositions I1, I4 and I5, even partially improved for the composition 14 (see in particular the stress at break and the M100 modulus before aging of composition I4 which are increased compared with those of the composition C1, and also that the compression sets of the composition I4 which are the same order as those of the composition C1); and
   a globally retained resistivity for the compositions I1-I5, even improved for the composition I1.

The resulting properties for the compositions I1-I5 according to the invention show, in comparison with the composition C2 not complying with the invention (comprising 100% of the same virgin carbon black as reinforcing filler):
in the non-crosslinked state, a globally retained suitability for use for the compositions I1-I5 and even improved for 11 (see, in particular, its reduced viscosity ML (1+4) compared to that of the composition C2); and
in the crosslinked state:
   mechanical properties not at all too penalized (even after thermal-oxidizing aging) for the compositions I1, 14 and 15, even partially improved for the composition I4 (see in particular the M100 modulus of composition I4 which is increased compared to that of the composition C2, and also that the compression sets of the compositions I4 and I5 which are the same order as those of the composition C2, and even reduced for the composition I4 at 72 hours/140° C.); and
   a resistivity very distinctly improved for the compositions I1-I5.

The resulting properties for the compositions I1-I5 according to the invention show, in comparison with the composition C3 not complying with the invention (comprising 100% of the same lignin as reinforcing filler):
in the non-crosslinked state, a very distinctly improved suitability for use for the compositions I1-I5 (see in particular their ML (1+4) viscosities which are very reduced compared to that of the composition C3 and their scorch times t5 overall longer than those of the composition C3); and
in the crosslinked state:
   globally improved mechanical properties even after thermal-oxidative aging for the compositions I1-I5 (see in particular the stresses and elongations at break, and also the compression sets for the compositions I4 and I5 which are of the same magnitude as that of the composition C3); and
   an improved resistivity for the compositions I1, I2, I3 and I5.

Table 5 below shows the essential rheological properties of the resulting compositions C4-C6 and I6-I8, including for each of them:
the Mooney ML (1+4) viscosity at 100° C. measured according to the ISO 289-1 standard;
the initial scorch time t5 without premature crosslinking at 135° C. according to the ISO 289-2 standard; and
the rheological properties: time ts1 and t10, t50, t70, t90 (beginning to end of crosslinking) measured by an oscillating matrix rheometer (20 minutes at 180° C.) according to the ISO 6502 standard

TABLE 5

| | | C4 | C5 | C6 | I6 | I7 | I8 |
|---|---|---|---|---|---|---|---|
| ML(1 + 4) at 100° C | | 45.4 | 45.8 | 45.5 | 45.1 | 44.3 | 47.9 |
| Scorch time t5 in | | 8.74 | 5.61 | 6.37 | 6.59 | 5.63 | 6.74 |
| minutes (30 minutes | | | | | | | |
| at 135° C.) | | | | | | | |
| Rheology: | ts1 | 4.51 | 1.26 | 1.28 | 1.76 | 1.32 | 1.63 |
| time in minutes | t10 | 1.03 | 1.04 | 0.92 | 0.98 | 0.88 | 1 |
| (20 minutes | t50 | 3.4 | 3.19 | 2.94 | 3.16 | 2.88 | 3.15 |
| at 180° C.) | t70 | 5.92 | 5.03 | 4.99 | 5.28 | 4.76 | 5.27 |
| | t90 | 11.6 | 9.66 | 10.61 | 10.76 | 9.94 | 10.66 |

Table 6 below shows the physical and mechanical properties of the resulting crosslinked compositions C4-C6 and I6-I8 measured as indicated above on dumbbell type test pieces.

TABLE 6

| | C4 | C5 | C6 | I6 | I7 | I8 |
|---|---|---|---|---|---|---|
| Density (g/cm³) | 1.132 | 1.229 | 1.235 | 1.199 | 1.215 | 1.216 |

Before thermal-oxidizing aging

| | | | | | | |
|---|---|---|---|---|---|---|
| Shore A hardness | 52 | 68 | 57 | 56 | 61 | 54 |
| Stress at break (MPa) | 6.44 | 15.4 | 12.3 | 10.3 | 11.8 | 10.4 |
| Elongation at break (%) | 307 | 323 | 349 | 302 | 338 | 340 |
| M100 modulus (MPa) | 2.57 | 5.03 | 3.27 | 3.33 | 3.63 | 3.13 |

After thermal-oxidizing aging for 168 hours at 150° C.

| | | | | | | |
|---|---|---|---|---|---|---|
| Shore A hardness | 53 | 73 | 69 | 74 | 78 | 69 |
| Δ Shore A hardness | 2 | 4 | 12 | 18 | 17 | 15 |
| Stress at break (MPa) | 6.8 | 13.3 | 5.7 | 8.0 | 10.5 | 8.2 |
| Δ (%) stress at break | 5% | −14% | −54% | −23% | −11% | −21% |
| Elongation at break (%) | 211 | 282 | 107 | 135 | 202 | 156 |
| Δ (%) elongation at break | −31% | −13% | −69% | −55% | −40% | −54% |

Compression Set

| | | | | | | |
|---|---|---|---|---|---|---|
| 25%: 72 hours/130° C. | 55.1 | 16.1 | 28.6 | 28.7 | 15.1 | 26.7 |
| after 30 minutes, | | | | | | |
| per ISO 815-1 | | | | | | |
| (method B) | | | | | | |
| 25%: 72 hr/140° C. | 93.7 | 69 | 68 | 72.9 | 71.6 | 70.9 |
| “FCA” per ISO 1817 | | | | | | |

Volume resistivity at 1000 V

| | | | | | | |
|---|---|---|---|---|---|---|
| In Ω · cm | 1.68 · | 5.6 · | 1.68 · | 1.68 · | 5.2 · | 1.6 · |
| | 10¹⁴ | 10⁵ | 10¹⁴ | 10¹⁴ | 10⁸ | 10¹⁴ |

The resulting properties for the compositions I6-I8 according to the invention show, in comparison with compositions C4-C6 not complying with the invention:
in the non-crosslinked state, a globally retained suitability for use for the compositions I6-I8; and
in the crosslinked state:
   mechanical properties not at all too penalized (even after thermal-oxidizing aging) for the compositions I6-I8 (see in particular the stress at break which is more than 7 MPa, and the elongation at break which is over 100% after thermal-oxidizing aging for 168 hours at 150° C.); and
   a resistivity very distinctly improved for the compositions I6-I8 in comparison with composition C5 comprising only virgin carbon black.

In conclusion, these examples show that:
the compositions I1-I8 according to the invention, in particular characterized by the coupling of a recycled carbon black with lignin, globally show properties in the non-crosslinked state and crosslinked state globally of the same order as the compositions C1-C3, and in particular that
the compositions I1, I2, I4, I5, I6, I7 and I8 further characterized by the addition to the recycled carbon black and lignin of a virgin carbon black even serve to further improve some of these properties compared to those of the compositions C1-C6, with even more specifically
the compositions I4 and I5, specifically further characterized by a fraction by mass of lignin in the reinforcing filler of about 17%, allow further improving some of these properties compared to the compositions C1-C3 (in comparison with compositions I1 and I2 whose reinforcing filler comprises about 33% and 67% of lignin, respectively).

These examples also show that the compositions according to the invention I1, I2, I3, I5, I6, I7 and I8 advantageously have a fraction by mass of sustainable ingredients (i.e. biosourced and recycled) which is over 10% (composition I7), over 20% (composition I6), over 25% (composition I8), even over 30% (compositions I2, I3 and I5) and even over 40% (composition I3).

These examples also show that the replacement of at least one part of the virgin carbon black by recycled carbon black makes it possible to improve the resistivity of the composition.

1. A rubber composition based on at least one elastomer, where the composition can be used to form in the crosslinked state at least one layer of a hose and comprises a reinforcing filler and a crosslinking system comprising sulfur and/or a peroxide, wherein the reinforcing filler comprises
at least one recycled carbon black coming from shredding or thermal decomposition of used rubber-based articles; and
a functionalized lignin in powdered form.

2. The rubber composition according to claim 1, wherein said at least one recycled carbon black has reinforcement properties of the composition analogous to those of reinforcing carbon black selected from the ASTM N300, N400, N500, N600 and N700 series.

3. The rubber composition according to claim 1, wherein the composition comprises, in addition to said at least one elastomer, the crosslinking system and the functionalized lignin:
a recycled pulverulent mixture which comprises the product of a thermal decomposition reaction by thermolysis, pyrolysis or de-vulcanization, applied to shreds of said used rubber-based articles;
the recycled pulverulent mixture comprising said at least one recycled carbon black.

4. The rubber composition according to claim 1, wherein the recycled pulverulent mixture comprises said at least one recycled carbon black according to a fraction by mass included between 80% and 99%, and inorganic substances at a fraction by mass included between 1% and 20%, comprising in particular silicon oxides and/or zinc compounds, where the recycled pulverulent mixture is in micronized form.

5. The rubber composition according to claim 1, wherein the functionalized lignin in powdered form:
comprises particles without surface CO or COO group; and/or
is a kraft lignin.

6. The rubber composition according to claim 1, wherein the reinforcing filler further comprises at least one virgin carbon black.

7. The rubber composition according to claim 1, wherein the composition comprises 10-120 PCE of said at least one recycled carbon black and 2-90 PCE of the functionalized lignin (PCE: parts by weight for 100 parts of elastomer(s)).

8. The rubber composition according to claim 1, wherein said at least one elastomer is selected from the ethylene-propylene-diene terpolymers (EPDM), the isobutylene-isoprene copolymers (IIR), the halogen isobutylene-isoprene copolymers (XIIR), the silicone rubbers, the fluoro silicone rubbers, acrylic rubbers, and the bromine copolymers of isobutylene-para-methylstyrene.

9. The rubber composition according to claim 8, wherein:
said at least one elastomer is made up of at least one EPDM;
the crosslinking system comprises a peroxide or sulfur; and
the composition comprises 15-100 PCE of said at least one recycled carbon black and 5-80 PCE of the functionalized lignin.

10. The rubber composition according to claim 6, wherein the composition comprises:
10-80 PCE of said at least one virgin carbon black;
15-80 PCE of said at least one recycled carbon black; and
15-80 PCE of said functionalized lignin;
where the sum of the quantities of said at least one virgin carbon black and said at least one recycled carbon black in the composition is 60-110 PCE.

11. The rubber composition according to claim 10, wherein the sum of the quantities of said at least one virgin carbon black and said at least one recycled carbon black in the composition is 70-100 PCE.
and wherein the sum of the quantities of said at least one virgin carbon black, of said at least one recycled carbon black, and said functionalized lignin in the composition is 100-130 PCE.

12. The rubber composition according to claim 10, wherein the reinforcing filler comprises:
the functionalized lignin according to a fraction by mass of 15-30%; and
said at least one virgin carbon black and said at least one recycled carbon black according to a fraction by total mass of carbon black of 70-85%.

13. The rubber composition according to claim 10, wherein the composition has in the crosslinked state a volume resistivity over 106 Ohm·cm, measured according to the IEC 62631 3 standard.

14. The rubber composition according to claim 1, wherein the composition has a fraction by mass of sustainable ingredients which include said at least one recycled carbon black and said functionalized lignin, that is over 25%.

15. A hose for transferring a liquid, gaseous or supercritical fluid for thermal engine or electric motor, or for fuel cell for an automobile, rail, aquatic, aerial or spatial vehicle, the hose comprising a radially inner tube, at least one reinforcing layer and one cover layer where the hose is suited for conveying the fluid at a pressure equal to or over 2×105 Pa, wherein at least of the inner tube and the covering layer is made up of a rubber composition in the crosslinked state according to claim 1.
